(19) United States
(12) Patent Application Publication
(10) Pub. No.: US 2026/0323145 A1
(43) Pub. Date: Oct. 15, 2026

(54) IMAGING DEVICE

(71) Applicant: Astemo, Ltd., Tokyo (JP)

(72) Inventors: Seiichi KATOU, Tokyo (JP); Keisuke MASUDA, Ibaraki (JP); Masahiko SOSHINO, Ibaraki (JP); Kazuya MATSUMARU, Ibaraki (JP)

(21) Appl. No.: 19/491,510

(22) PCT Filed: Jun. 12, 2024
(86) PCT No.: PCT/JP2024/021336

§ 371 Date: Dec. 9, 2025

(30) Foreign Application Priority Data
Jun. 23, 2023 (JP) 2023-103587

(51) Int. Cl. H04N 23/52; G02B 7/02; H04N 23/54

(52) U.S. Cl. CPC H04N 23/52; G02B 7/02; H04N 23/54

(57) ABSTRACT

An imaging device capable of reducing an optical axis deviation of an optical lens with respect to an imaging element caused by thermal deformation of components. The substrate includes a narrow portion that surrounds a partial portion of an outer periphery of the imaging element inside the holder base part, and a wide portion that surrounds the remaining portion of the outer periphery of the imaging element inside the holder base part, the wide portion being wider than the narrow portion. The imaging device includes a displacement adjustment part that makes relative displacement between the lens barrel and the substrate in a direction in which the imaging element moves from the narrow portion toward the wide portion easier than relative displacement between the lens barrel and the substrate in the opposite direction.

### TECHNICAL FIELD

The present disclosure relates to an imaging device.

### BACKGROUND ART

Conventionally, a stereo-type imaging device that images the same measurement target from different viewpoints has been known. In a stereo-type imaging device described in PTL 1 listed below, a pair of cameras, each having an optical lens and an imaging element, are provided at a predetermined interval, a region where imaging regions of the cameras overlap is a field of view, parallax between the cameras is detected by searching for corresponding points, and distance data is calculated from the parallax by an image processing means using the principle of triangulation.

In the imaging device according to PTL 1, the center of the imaging element is offset in a predetermined interval direction with respect to the optical axis of the optical lens so as to increase the field of view. Then, a corresponding point confirmed in an image captured by one of the cameras is used as a search start reference point for searching for a corresponding point in an image of the other camera. This makes it possible to ensure a sufficient field of view, and perform a high-speed processing operation without increasing the cost associated with calculation processing.

Further, a camera module described in PTL 2 listed below includes a camera lens unit having a lens, a camera housing that supports the camera lens unit, and a substrate fixed to the camera housing via an adhesive. An image sensor facing the lens is attached to the substrate. The camera module includes a first notch formed in the camera housing or the substrate, an inner joining region to which the adhesive is applied, and an outer joining region to which the adhesive is applied.

The inner joining region is set on a side closer to the image sensor with the first notch as a boundary in the camera housing or the substrate in which the first notch is formed. In addition, the outer joining region is set on a side farther from the image sensor with the first notch as a boundary in the camera housing or the substrate in which the first notch is formed. This makes it possible to appropriately set the joining regions of the adhesives, thereby suppressing the optical axis deviation caused by shrinkage of the adhesive when thermally cured.

### CITATION LIST

### Patent Literature

PTL 1: JP 2014-238558 A
PTL 2: JP 2022-165432 A

### SUMMARY OF INVENTION

### Technical Problem

In the imaging element (or image sensor), due to high performance, such as wider angle of view, higher precision, and faster processing speed, of the imaging device (or camera module), the increase in the number of pixels, the decrease in tolerance for the optical axis deviation of the optical lens, the increase in amount of heat generation, and the like are remarkable. As a result, the amount of thermal deformation of the components constituting the imaging device increases, making it more likely that the optical axis deviation of the optical lens with respect to the imaging element occurs.

The present disclosure provides an imaging device capable of reducing an optical axis deviation of an optical lens with respect to an imaging element caused by thermal deformation of components.

### Solution to Problem

According to an aspect of the present disclosure, an imaging device includes: a lens holder that holds an optical lens; a substrate on which an imaging element having an imaging surface intersecting with an optical axis of the optical lens is mounted; and a joining part that joins the lens holder to the substrate, in which the lens holder includes a lens barrel that holds the optical lens, and a holder base part that supports the lens barrel and is joined to the substrate via the joining part to surround the imaging element, the substrate includes a narrow portion that surrounds a partial portion of an outer periphery of the imaging element inside the holder base part, and a wide portion that surrounds the remaining portion of the outer periphery of the imaging element inside the holder base part, the wide portion being wider than the narrow portion, and the imaging device further includes a displacement adjustment part that makes relative displacement between the lens barrel and the substrate in a direction in which the imaging element moves from the narrow portion toward the wide portion easier than relative displacement between the lens barrel and the substrate in a direction in which the imaging element moves from the wide portion toward the narrow portion.

### Advantageous Effects of Invention

According to the above-described aspect of the present disclosure, it is possible to provide an imaging device capable of reducing an optical axis deviation of an optical lens with respect to an imaging element caused by thermal deformation of components.

### BRIEF DESCRIPTION OF DRAWINGS

FIG. 1 is a perspective view illustrating an imaging device according to a first embodiment of the present disclosure.

FIG. 2 is a perspective view illustrating an internal structure of a housing of the imaging device of FIG. 1.

FIG. 3 is a perspective view of a lens holder, a substrate, and a joining part of the imaging device of FIG. 1.

FIG. 4A is a cross-sectional view of the imaging device taken along line IV (A)-IV (A) of FIG. 3.

FIG. 4B is a cross-sectional view of the imaging device taken along line IV(B)-IV(B) of FIG. 3.

FIG. 5A is a cross-sectional view of a conventional imaging device, corresponding to FIG. 4A.

FIG. 5B is a cross-sectional view of a conventional imaging device, corresponding to FIG. 4A.

FIG. 6 is a cross-sectional view illustrating a first modification of the imaging device according to the first embodiment, corresponding to FIG. 4A.

FIG. 7 is a cross-sectional view illustrating a second modification of the imaging device according to the first embodiment, corresponding to FIG. 4A.

FIG. 8 is a cross-sectional view illustrating a third modification of the imaging device according to the first embodiment, corresponding to FIG. 4A.

FIG. 9 is a perspective view illustrating a fourth modification of the imaging device according to the first embodiment, corresponding to FIG. 3.

FIG. 10 is a cross-sectional view of the imaging device taken along line X-X of FIG. 9.

FIG. 11 is a cross-sectional view illustrating an imaging device according to a second embodiment of the present disclosure, corresponding to FIG. 4B.

FIG. 12 is cross-sectional view illustrating an imaging device according to a third embodiment of the present disclosure, corresponding to FIG. 4B.

FIG. 13 is a perspective view illustrating an imaging device according to a fourth embodiment of the present disclosure, corresponding to FIG. 3.

FIG. 14 is a perspective view illustrating a first modification of the imaging device according to the fourth embodiment, corresponding to FIG. 3.

FIG. 15 is a perspective view illustrating a second modification of the imaging device according to the fourth embodiment, corresponding to FIG. 3.

FIG. 16 is a perspective view illustrating a third modification of the imaging device according to the fourth embodiment, corresponding to FIG. 3.

### DESCRIPTION OF EMBODIMENTS

Hereinafter, imaging devices according to embodiments of the present disclosure will be described with reference to the drawings.

### First Embodiment

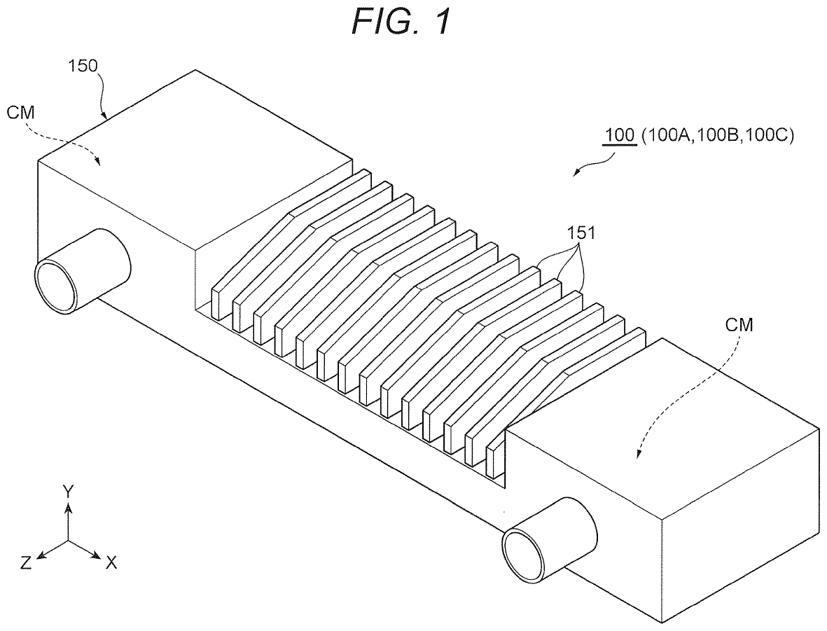

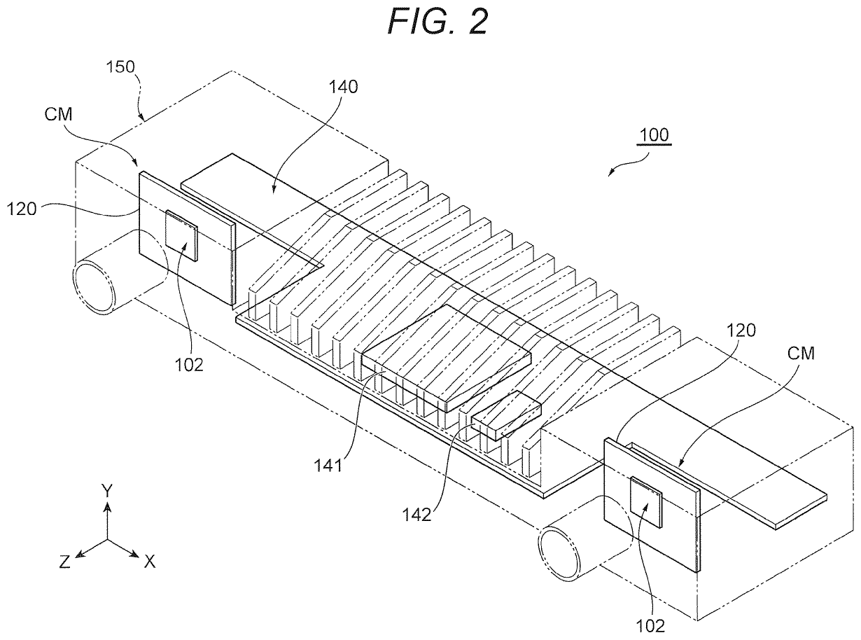

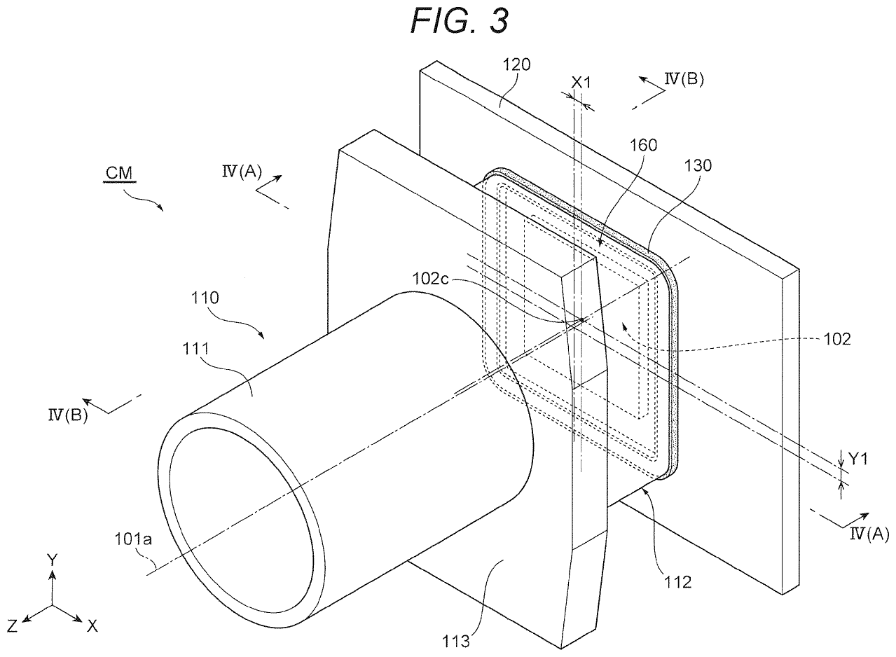

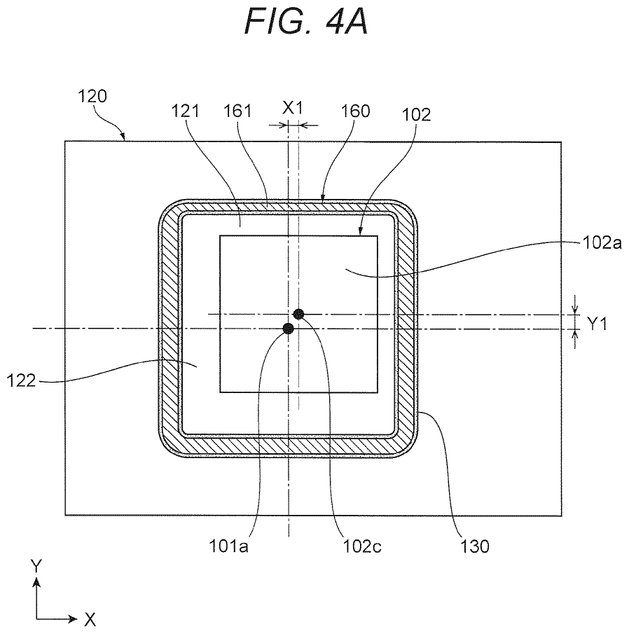

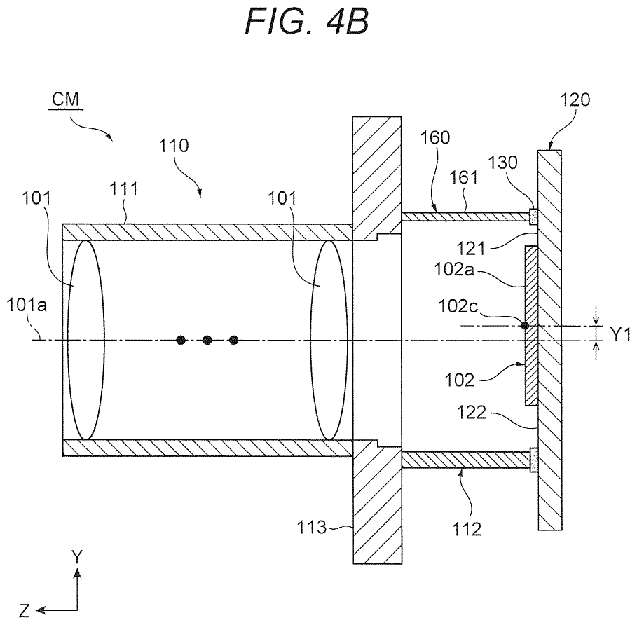

FIG. 1 is a perspective view illustrating an imaging device according to a first embodiment of the present disclosure. FIG. 2 is a perspective view illustrating an internal structure of a housing 150 of the imaging device 100 of FIG. 1. FIG. 3 is a perspective view of a lens holder 110, a substrate 120, and a joining part 130 constituting a camera module CM of the imaging device 100 of FIG. 1. FIG. 4A is a cross-sectional view of the imaging device 100 taken along line IV (A)-IV (A) of FIG. 3, and FIG. 4B is a cross-sectional view of the imaging device 100 taken along line IV(B)-IV(B) of FIG. 3. In FIG. 2, the lens holder 110 and the joining part 130 are not illustrated in order to illustrate the substrate 120 inside the housing 150.

The imaging device 100 according to the present embodiment is, for example, a camera device attached to a self-driving vehicle or a vehicle equipped with an advanced driver assistance system (ADAS) to detect an object around the vehicle. In each drawing, a three-dimensional orthogonal coordinate system is shown, including an X axis along the width direction of the vehicle, a Y axis along the height direction of the vehicle, and a Z axis along the front-rear direction of the vehicle. Hereinafter, the positional relationships between components of the imaging device 100 may be described using this three-dimensional orthogonal coordinate system.

The imaging device 100 includes, for example, a camera module CM including a lens holder 110 that holds an optical lens 101, a substrate 120 on which an imaging element 102 is mounted, and a joining part 130 that joins the lens holder 110 to the substrate 120. The imaging element 102 mounted on each substrate 120 has an imaging surface 102a orthogonal to or intersecting with an optical axis 101a of the optical lens 101 held by each lens holder 110.

The imaging device 100 is, for example, a stereo camera device including a pair of left and right camera modules CM. Furthermore, the imaging device 100 includes, for example, a circuit board 140 disposed between the pair of left and right camera modules CM, and a housing 150 that accommodates and fixes the circuit board 140 and the pair of left and right camera modules CM.

The lens holder 110 includes a lens barrel 111 that holds the optical lens 101, and a holder base part 112 that supports the lens barrel 111 and is joined to the substrate 120 via the joining part 130 to surround the imaging element 102. The lens barrel 111 is, for example, provided in a circular tubular shape with its central axis coinciding with the optical axis 101a of the optical lens 101. The holder base part 112 is, for example, provided in a rectangular tubular shape to surround the rectangular imaging element 102.

In addition, the lens holder 110 includes, for example, a flange part 113 provided between the lens barrel 111 and the holder base part 112. The flange part 113 is, for example, a plate-like part protruding in the radial direction of the lens barrel 111, and is fixed to the housing 150 of the imaging device 100. The lens holder 110 is molded from a resin material such as polyphenylene sulfide (PPS) or polyphthalamide (PPA).

The substrate 120 is an imaging element substrate on which the imaging element 102 is mounted. The substrate 120 is made of a material such as glass epoxy. Furthermore, as illustrated in FIG. 4A, the substrate 120 includes a narrow portion 121 that surrounds a partial portion of an outer periphery of the imaging element 102 inside the holder base part 112, and a wide portion 122 that surrounds the remaining portion of the outer periphery of the imaging element 102 inside the holder base part 112, the wide portion 122 being wider than the narrow portion 121. More specifically, the narrow portion 121 surrounds two sides adjacent to each other of the rectangular imaging element 102, and the wide portion 122 surrounds the other two sides adjacent to each other of the rectangular imaging element 102.

More specifically, the lens barrel 111 of the lens holder 110 holds the optical lens 101, for example, in a state where the optical axis 101a of the optical lens 101 is offset from the center 102c of the imaging surface 102a of the imaging element 102. In addition, the holder base part 112 of the lens holder 110 is, for example, provided coaxially with the lens barrel 111. Then, the narrow portion 121 of the substrate 120 surrounds a partial portion of the outer periphery of the imaging element 102, for example, on a side opposite to the offset side of the optical axis 101a of the optical lens 101 with respect to the center 102c of the imaging surface 102a of the imaging element 102. In addition, the wide portion 122 surrounds the remaining portion of the outer periphery of the imaging element 102 on the offset side of the optical axis 101a.

In the present embodiment, the offset direction of the optical axis 101a of the optical lens 101 with respect to the center 102c of the imaging surface 102a of the imaging element 102 is, for example, inward in the width direction (X-axis direction) of the vehicle and downward in the vertical direction (Y-axis direction) of the vehicle. In addition, the two sides of the imaging element 102 adjacent to the narrow portion 121 of the substrate 120 are, for example, an upper edge of the imaging element 102 along the width direction of the vehicle and a side edge of the imaging element 102 along the vertical direction of the vehicle on the outer side in the width direction of the vehicle. In addition, the sides of the imaging element 102 adjacent to the wide portion 122 of the substrate 120 are, for example, a lower edge of the imaging element 102 along the width direction of the vehicle and a side edge of the imaging element 102 along the vertical direction of the vehicle on the inner side in the width direction of the vehicle.

The joining part 130 can be formed, for example, using an adhesive, solder, or the like depending on the material of the lens holder 110. In the present embodiment, for example, the joining part 130 is provided over the entire periphery of the open end of the holder base part 112, and joins the entire periphery of the open end of the holder base part 112 to the substrate 120.

The circuit board 140 includes, for example, a plurality of circuit elements 141 and 142. The circuit element 141 includes, for example, a signal processing element, such as a microcontroller that processes images captured by the imaging element 102, a field programmable gate array (FPGA), or an application specific integrated circuit (ASIC). The circuit element 142 includes, for example, a memory such as a ROM or a RAM.

The housing 150 accommodates, for example, the CM camera module and the circuit board 140, and supports and fixes the CM camera module and the circuit board 140. That is, each of the camera module CM and the circuit board 140 is accommodated in the housing 150 and fixed to the housing 150. The housing 150 includes, for example, a plurality of heat dissipation fins 151. In addition, the housing 150 is made of metal such as aluminum, thereby making it possible to improve heat dissipation and the electromagnetic shielding in addition to dust-proofness. Although not illustrated, the housing 150 has, for example, an opening through which wiring for connecting the circuit board 140 to an electronic control device of the vehicle is inserted.

Furthermore, the imaging device 100 includes, for example, a displacement adjustment part 160 as illustrated in FIGS. 4A and 4B. The displacement adjustment part 160 makes relative displacement between the lens barrel 111 and the substrate 120 in a direction in which the imaging element 102 moves from the narrow portion 121 toward the wide portion 122 easier than relative displacement between the lens barrel 111 and the substrate 120 in a direction in which the imaging element 102 moves from the wide portion 122 toward the narrow portion 121. In the present embodiment, the displacement adjustment part 160 includes, for example, a thin portion 161 in which the holder base part 112 of the lens holder 110 is thinner in a portion adjacent to the narrow portion 121 of the substrate 120 than in the other portion.

For example, the thin portion 161 can be a wall portion constituting one side of the rectangular holder base part 112 facing one side of the rectangular substrate 120 adjacent to the narrow portion 121, which is thinner than wall portions constituting the other three sides of the holder base part 112. More specifically, the thin portion 161 can be an upper wall portion of the rectangular holder base part 112 facing the upper edge of the rectangular imaging element 102 adjacent to the narrow portion 121, which is thinner than the left and right side wall portions and the bottom wall portion of the holder base part 112.

Note that the difference between the thickness of the thin portion 161 and the thickness of the other portion in the holder base part 112 can be, for example, proportional to offset amounts X1 and Y1 of the optical axis 101a of the optical lens 101 with respect to the center 102c of the imaging surface 102a of the imaging element 102. More specifically, for example, as the offset amounts X1 and Y1 of the optical axis 101a with respect to the center 102c of the imaging surface 102a increase, the difference between the thickness of the thin portion 161 and the thickness of the other portion in the holder base part 112 is increased.

Hereinafter, the operation of the imaging device 100 according to the present embodiment will be described in comparison with a conventional imaging device.

In recent years, in order to realize a safe and comfortable vehicular society, the practical application of self-driving vehicles and the spread of ADAS-equipped vehicles have been progressing. In order to implement functions such as autonomous emergency braking system (AEBS), (ACC), lane departure prevention adaptive cruise control (LDP), and traffic sign recognition (TSR), these vehicles are equipped with imaging devices 100 such as monocular camera devices and stereo camera devices that detect objects around the vehicles.

The stereo camera device extracts a feature point common to left and right images captured by the left and right camera modules, and measures a distance to the feature point based on a parallax in which a positional deviation of the feature point in each of the left and right images is represented by the number of pixels. Therefore, if a deviation other than parallax occurs in each of the left and right images, an error occurs in the result of measuring the distance to the feature point. One of the causes of the deviation other than the parallax generated between the left and right images is, for example, thermal deformation of the components of the stereo camera device due to heat from sunlight or heat generated by the circuit elements inside the device. If the components of the stereo camera device are thermally deformed, there may be a positional deviation of the optical axis of the optical lens on the imaging surface of the imaging element due to a difference in linear expansion coefficient between the components.

In addition, as the performance of the stereo camera device improves, including wider angle of view, higher precision, and faster processing speed, the tolerance for positional deviation of the optical axis of the optical lens on the imaging surface of the imaging element decreases, and there is a demand for further reduction in optical axis deviation. Furthermore, the number of pixels in the imaging element is increasing, and the amount of heat generated by circuit elements that process images is also increasing. On the other hand, as the stereo camera device becomes smaller, the surface area of the housing decreases, and the heat dissipation deteriorates. Therefore, the temperatures of the components of the stereo camera rise, making them more susceptible to thermal deformation.

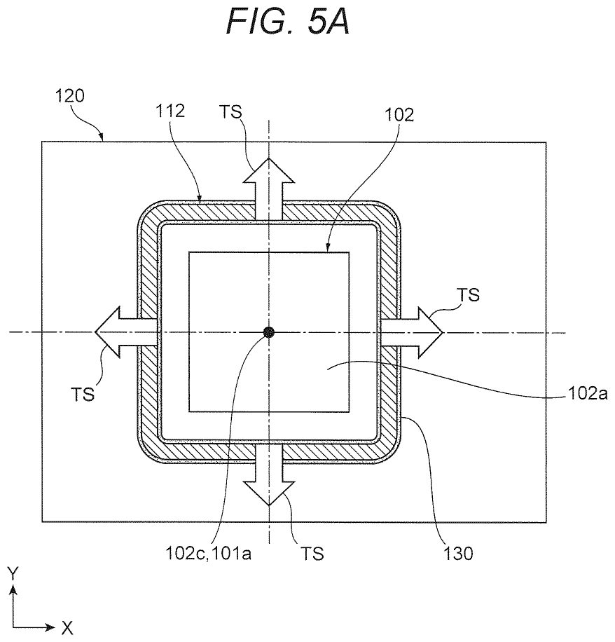

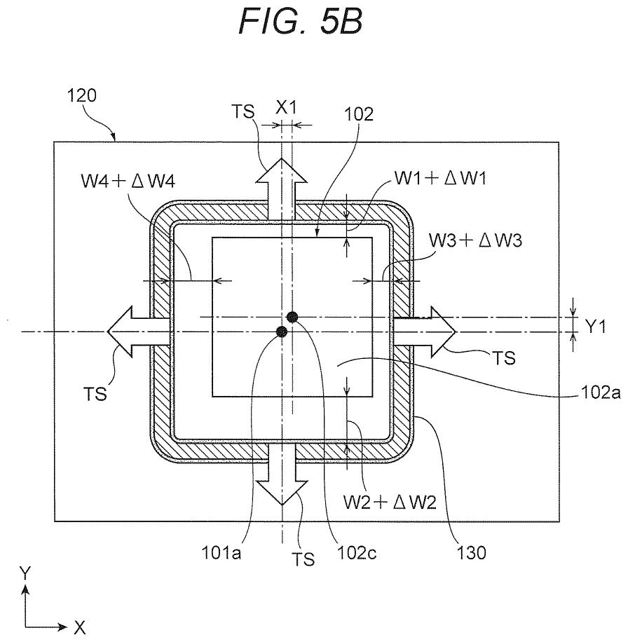

FIGS. 5A and 5B are cross-sectional views of conventional imaging devices, corresponding to FIG. 4A. In the conventional imaging device illustrated in FIG. 5A, the position of the center 102c of the imaging surface 102a of the imaging element 102 and the position of the optical axis 101a of the optical lens 101 coincide with each other, and the width of the substrate 120 between the holder base part 112 of the lens holder 110 and the imaging element 102 is substantially constant over the entire outer periphery of the imaging element 102. In this case, the thermal stress TS acting on the substrate 120 between the imaging element 102 and the holder base part 112 from the holder base part 112 is symmetrical vertically and horizontally, and there is no deviation of the optical axis 101a of the optical lens 101 with respect to the imaging element 102.

In the conventional imaging device illustrated in FIG. 5B, the position of the optical axis 101a of the optical lens 101 is offset from the center 102c of the imaging surface 102a of the imaging element 102 by predetermined offset amounts X1 and Y1. In this case, for example, there is a difference between widths W1 and W2 of the substrate 120 between the holder base part 112 of the lens holder 110 and the imaging element 102 in the vertical direction (Y-axis direction) of the vehicle. In addition, for example, there is a difference between widths W3 and W4 of the substrate 120 between the holder base part 112 of the lens holder 110 and the imaging element 102 in the width direction (X-axis direction) of the vehicle.

For example, in the example illustrated in FIG. 5B, the width W1 of the substrate 120 on the upper side of the imaging element 102 is narrower than the width W2 of the substrate 120 on the lower side of the imaging element 102 in the vertical direction of the vehicle. In addition, the width W3 of the substrate 120 on the outer side of the imaging element 102 is narrower than the width W4 of the substrate 120 on the inner side in the width direction of the vehicle. In this case, when the temperatures of the substrate 120, the imaging element 102, and the lens holder 110 rise, due to differences in linear expansion coefficients between the components, thermal stresses TS that are substantially equal vertically and horizontally act on the substrate 120 between the holder base part 112 and the imaging element 102 outward from the holder base part 112.

Furthermore, in the substrate 120, differences in rigidity and linear expansion coefficient occur between a portion where the imaging element 102 is mounted and a portion between the holder base part 112 and the imaging element 102. As a result, an expansion amount AW1 of the substrate 120 in the portion of the upper width W1 of the imaging element 102 is smaller than an expansion amount AW2 of the substrate 120 in the portion of the lower width W2 of the imaging element 102 (AW1<AW2). Furthermore, in the width direction of the vehicle, an expansion amount AW3 of the substrate 120 in the portion of the outer width W3 of the imaging element 102 is smaller than an expansion amount AW4 of the substrate 120 in the portion of the inner width W4 of the imaging element 102 (AW3<AW4).

As a result, the positions of the imaging element 102 and the center 102c of the imaging surface 102a move upward in the vertical direction of the vehicle and outward in the width direction of the vehicle. On the other hand, since the holder base part 112 of the lens holder 110 is thermally deformed equally vertically and horizontally, the position of the optical axis 101a of the optical lens 101 held by the lens holder 110 does not substantially change. As a result, an optical axis deviation occurs in which the offset amounts X1 and Y1 of the optical axis 101a of the optical lens 101 with respect to the center 102c of the imaging surface 102a of the imaging element 102 increase, and the accuracy of the imaging device in measuring the distance and direction of the object.

In order to solve the problems of the conventional imaging devices, the imaging device 100 according to the present embodiment has the following configuration. The imaging device 100 includes a lens holder 110 that holds an optical lens 101, a substrate 120 on which an imaging element 102 having an imaging surface 102a intersecting with an optical axis 101a of the optical lens 101 is mounted, and a joining part 130 that joins the lens holder 110 to the substrate 120. The lens holder 110 includes a lens barrel 111 that holds the optical lens 101, and a holder base part 112 that supports the lens barrel 111 and is joined to the substrate 120 via the joining part 130 to surround the imaging element 102. The substrate 120 includes a narrow portion 121 that surrounds a partial portion of an outer periphery of the imaging element 102 inside the holder base part 112, and a wide portion 122 that surrounds the remaining portion of the outer periphery of the imaging element 102 inside the holder base part 112, the wide portion 122 being wider than the narrow portion 121. The imaging device 100 further includes a displacement adjustment part 160 that makes relative displacement between the lens barrel 111 and the substrate 120 in a direction in which the imaging element 102 moves from the narrow portion 121 toward the wide portion 122 easier than relative displacement between the lens barrel 111 and the substrate 120 in a direction in which the imaging element 102 moves from the wide portion 122 toward the narrow portion 121.

With such a configuration, in the imaging device 100 according to the present embodiment, when the temperatures of the lens holder 110 and the substrate 120 rise, thermal stress acts on the substrate 120 from the holder base part 112 due to a difference in linear expansion coefficient between the lens holder 110 and the substrate 120. Then, the thermal stress acts on the narrow portion 121 and the wide portion 122, expanding their widths. However, since the narrow portion 121 is narrower than the wide portion 122, the amount of deformation of the narrow portion 121 is smaller than the amount of deformation of the wide portion 122, and the imaging element 102 attempts to move from the wide portion 122 toward the narrow portion 121. However, the imaging device 100 according to the present embodiment includes a displacement adjustment part 160.

This makes the relative displacement between the lens barrel 111 and the substrate 120 in a direction in which the imaging element 102 moves from the narrow portion 121 toward the wide portion 122 easier than the relative displacement between the lens barrel 111 and the substrate 120 in a direction in which the imaging element 102 moves from the wide portion 122 toward the narrow portion 121. As a result, the displacement adjustment part 160 promotes movement of the imaging element 102 in a direction from the narrow portion 121 toward the wide portion 122, and offsets movement of the imaging element 102 in a direction from the wide portion 122 toward the narrow portion 121 due to the thermal stress.

This reduces an optical axis deviation, which is a relative displacement between the optical axis 101a of the optical lens 101 held by the lens barrel 111 and the center 102c of the imaging surface 102a of the imaging element 102. Therefore, the measurement accuracy and reliability of the imaging device 100 are improved. Furthermore, it is possible to provide an imaging device 100 capable of reducing the optical axis deviation with respect to any arrangement of the imaging element 102, and having high measurement accuracy and reliability against temperature changes.

Furthermore, in the imaging device 100 according to the present embodiment, the displacement adjustment part 160 includes a thin portion 161 by which the holder base part 112 is thinner in a portion adjacent to the narrow portion 121 than in the other portion.

With such a configuration, in the holder base part 112 of the lens holder 110, the rigidity of the thin portion 161 adjacent to the narrow portion 121 can be lower than the rigidity of the other portion adjacent to the wide portion 122. As a result, the thermal stress acting on the narrow portion 121 from the thin portion 161 can be lower than the thermal stress acting on the wide portion 122 from the other portion of the holder base part 112. In addition, the substrate 120 can be easily displaced toward the wide portion 122. This makes relative displacement between a partial portion of the holder base part 112 adjacent to the narrow portion 121 and the substrate 120 easier than relative displacement between the other portion of the holder base part 112 adjacent to the wide portion 122 and the substrate 120, thereby reducing the optical axis deviation.

Furthermore, in the imaging device 100 according to the present embodiment, the lens barrel 111 holds the optical lens 101 in a state where the optical axis 101a is offset from the center 102c of the imaging surface 102a of the imaging element 102. The holder base part 112 is provided in a tubular shape coaxially with the lens barrel 111. The narrow portion 121 surrounds a partial portion of the outer periphery of the imaging element 102 on the side opposite to the offset side of the optical axis 101a with respect to the center 102c of the imaging surface 102a. The wide portion surrounds the remaining portion of the outer periphery of the imaging element 102 on the offset side of the optical axis 101a with respect to the center 102c of the imaging surface 102a.

With such a configuration, the optical axis 101a can be offset from the center 102c of the imaging surface 102a of the imaging element 102 to widen the angle of view of the imaging device 100. On the other hand, the amount of deformation of the substrate 120 due to the thermal stress caused by the difference in the linear expansion coefficient between the lens holder 110 and the substrate 120 of the imaging device 100 is larger in the wide portion 122 than in the narrow portion 121. However, since the imaging device 100 according to the present embodiment includes a displacement adjustment part 160, it is possible to reduce the displacement of the center 102c of the imaging surface 102a of the imaging element 102 with respect to the optical axis 101a of the optical lens 101 held by the lens holder 110, thereby reducing the optical axis deviation, as described above.

Furthermore, in the imaging device 100 according to the present embodiment, the displacement adjustment part 160 includes a thin portion 161 by which the holder base part 112 is thinner in a portion adjacent to the narrow portion 121 than in the other portion. In addition, the difference between the thickness of the thin portion 161 and the thickness of the other portion of the holder base part 112 is proportional to the offset amounts X1 and Y1 of the optical axis 101a with respect to the center of the imaging surface 102a.

With such a configuration, the difference between the thickness of the thin portion 161 and the thickness of the other portion of the holder base part 112 can be adjusted according to the offset amounts X1 and Y1. Therefore, it is possible to more reliably reduce the displacement of the center 102c of the imaging surface 102a of the imaging element 102 with respect to the optical axis 101a of the optical lens 101 held by the lens holder 110, thereby more reliably reducing the optical axis deviation.

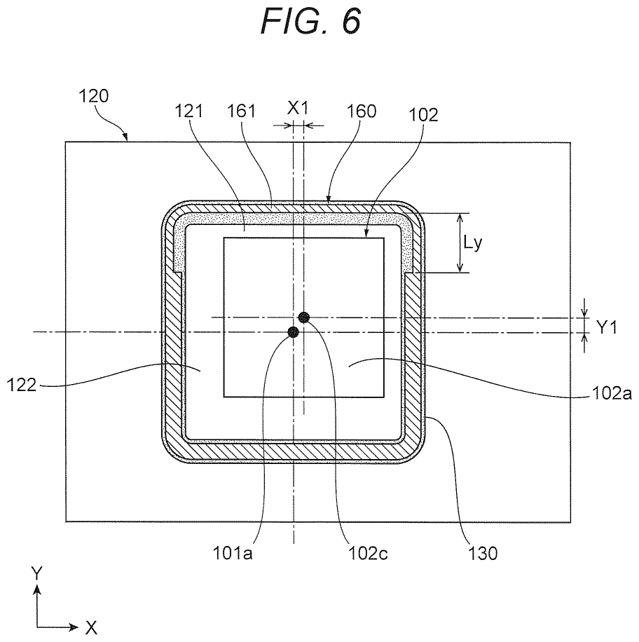

As described above, according to the present embodiment, it is possible to provide an imaging device 100 capable of reducing the optical axis deviation of the optical lens 101 with respect to the imaging element 102 caused by thermal deformation of the components. Note that the imaging device 100 according to the present embodiment is not limited to the above-described configuration. First to fourth modifications of the imaging device 100 according to the present embodiment will be described below with reference to FIGS. 6 to 9.

FIG. 6 is a cross-sectional view illustrating a first modification of the imaging device 100 according to the first embodiment, corresponding to FIG. 4A. In the present modification, the thin portion 161 includes not only the upper wall portion of the rectangular holder base part 112 adjacent to the narrow portion 121 but also upper end portions of the left and right side wall portions of the holder base part 112. Further, a step is formed between the thin portion 161 and the other portion of the holder base part 112. In this manner, by providing the step between the thin portion 161 and the other portion of the holder base part 112, stress can be concentrated at the step, making the deformation of the upper wall portion of the rectangular holder base part 112 uniform and promoting the deformation.

In addition, by adjusting the length Ly of the thin portion 161 in the upper end portions of the left and right side wall portions of the rectangular holder base part 112, the amount of movement of the imaging element 102 with respect to the holder base part 112 can be adjusted even if the temperatures of the lens holder 110 and the substrate 120 of the imaging device 100 change. Therefore, in the present modification, it is also possible to provide an imaging device 100 capable of achieving the same effects as that of the first embodiment described above, and reducing the optical axis deviation of the optical lens 101 with respect to the imaging element 102 caused by thermal deformation of the components. Note that the displacement adjustment part 160 including a thin portion 161 is desirably provided in the width direction of the vehicle where the tolerance for optical axis deviation is smaller.

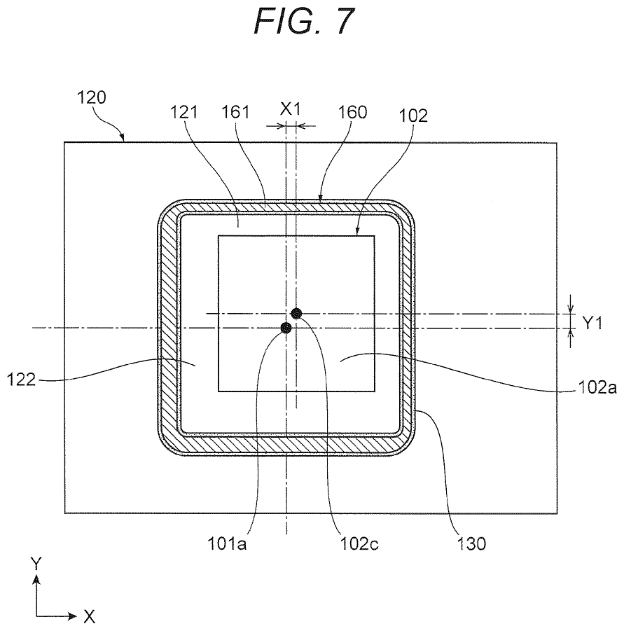

FIG. 7 is a cross-sectional view illustrating a second modification of the imaging device 100 according to the first embodiment, corresponding to FIG. 4A. In the present modification, the thin portion 161 includes wall portions constituting two sides of the rectangular holder base part 112 facing two sides of the rectangular substrate 120 adjacent to the narrow portion 121, which are thinner than wall portions constituting the other two sides of the holder base part 112. More specifically, the thin portion 161 can include an upper wall portion and a side wall portion of the rectangular holder base part 112 facing an upper edge and a side edge on the outer side in the width direction of the vehicle of the rectangular imaging element 102 adjacent to the narrow portion 121, which are thinner than a bottom wall portion and a side wall portion on the inner side in the width direction of the vehicle of the holder base part 112.

With such a configuration, the thin portion 161 can promote not only downward displacement of the imaging element 102 with respect to the holder base part 112 but also inward displacement of the imaging element 102 with respect to the holder base part 112 in the width direction of the vehicle. As a result, it is possible to reduce the optical axis deviation in both the vertical direction and the width direction of the vehicle. Therefore, in the present modification, it is also possible to provide an imaging device 100 capable of achieving the same effects as that of the first embodiment described above, and reducing the optical axis deviation of the optical lens 101 with respect to the imaging element 102 caused by thermal deformation of the components. Note that the thicknesses of the wall portions constituting the respective sides of the rectangular holder base part 112 can be different from each other in order to realize any difference in rigidity between the wall portions.

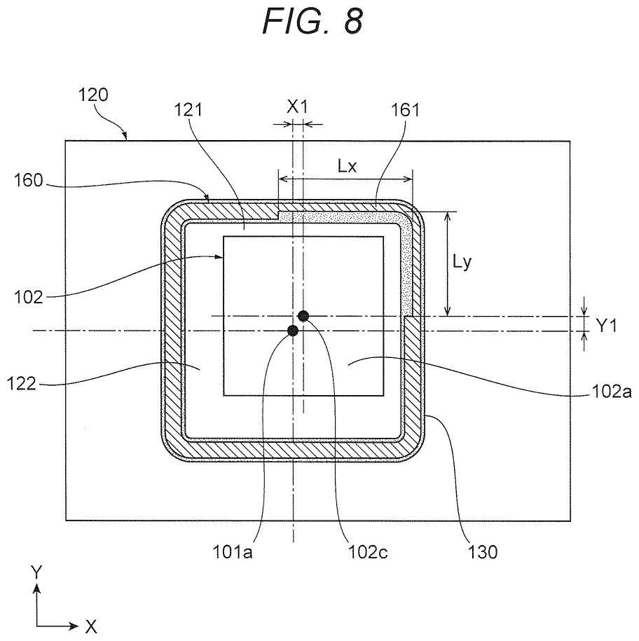

FIG. 8 is a cross-sectional view illustrating a third modification of the imaging device 100 according to the first embodiment, corresponding to FIG. 4A. In the present modification, the thin portion 161 includes partial portions of wall portions constituting two sides of the rectangular holder base part 112 facing two sides of the rectangular substrate 120 adjacent to the narrow portion 121, which are thinner than the other portions of those wall portions and wall portions constituting the other two sides of the holder base part 112. Here, the lengths Ly and Lx of the thin portion 161 in the width direction and the vertical direction of the vehicle can be adjusted according to the offset amounts X1 and Y1.

With such a configuration, the optical axis deviation can be reduced by fixing the thicknesses of the thin portion 161 and the other portion of the holder base part 112 and adjusting the lengths Ly and Lx of the thin portion 161 according to the offset amounts X1 and Y1. Therefore, the fine thickness adjustment of each wall portion of the holder base part 112 is not necessary, making it possible to facilitate dimensional management during manufacturing and improve dimensional accuracy. Therefore, in the present modification, it is also possible to provide an imaging device 100 capable of achieving the same effects as that of the first embodiment described above, and reducing the optical axis deviation of the optical lens 101 with respect to the imaging element 102 caused by thermal deformation of the components.

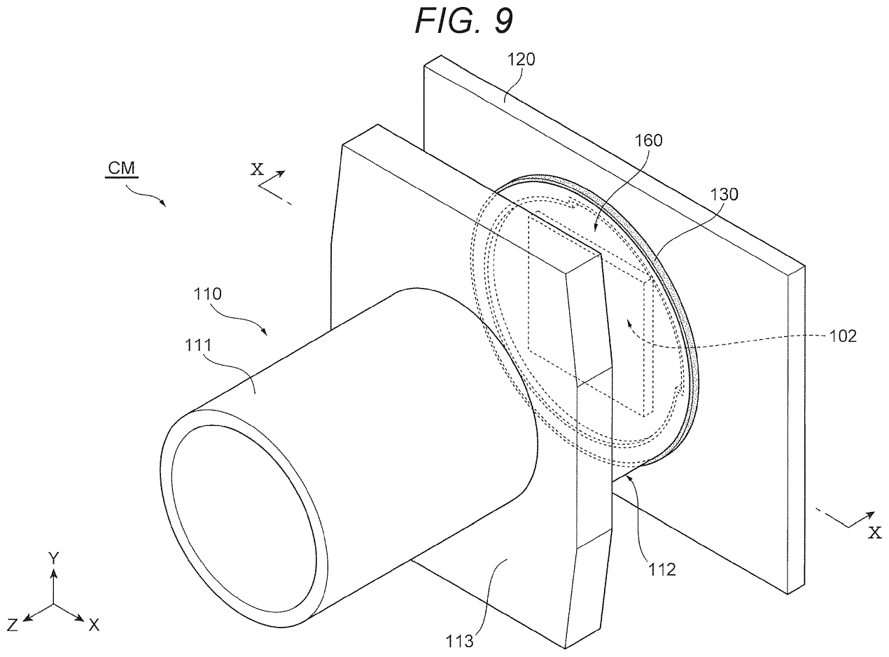

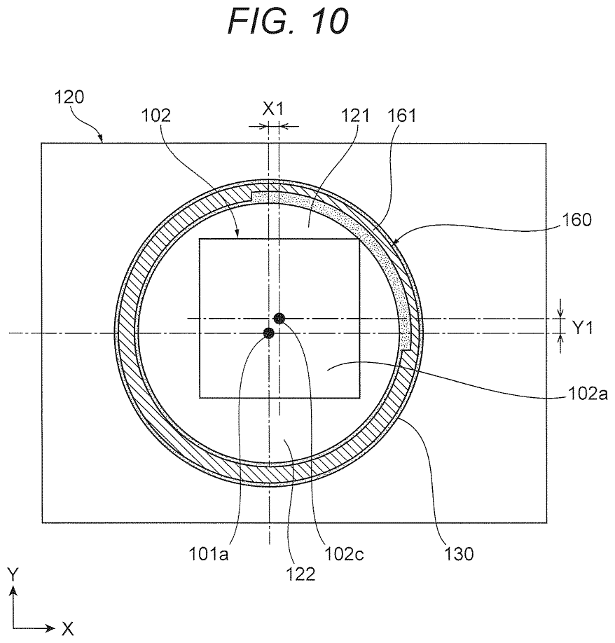

FIG. 9 is a perspective view illustrating a fourth modification of the imaging device 100 according to the first embodiment, corresponding to FIG. 3 FIG. 10 is a cross-sectional view of the imaging device 100 taken along line X-X of FIG. 9. In the present modification, the holder base part 112 of the lens holder 110 has a circular tubular shape rather than a rectangular tubular shape. In the present modification as well, the displacement adjustment part 160 includes a thin portion 161 in which the holder base part 112 is thinner in a portion adjacent to the narrow portion 121 than in the other portion. Therefore, in the present modification, it is also possible to provide an imaging device 100 capable of achieving the same effects as that of the first embodiment described above, and reducing the optical axis deviation of the optical lens 101 with respect to the imaging element 102 caused by thermal deformation of the components.

### Second Embodiment

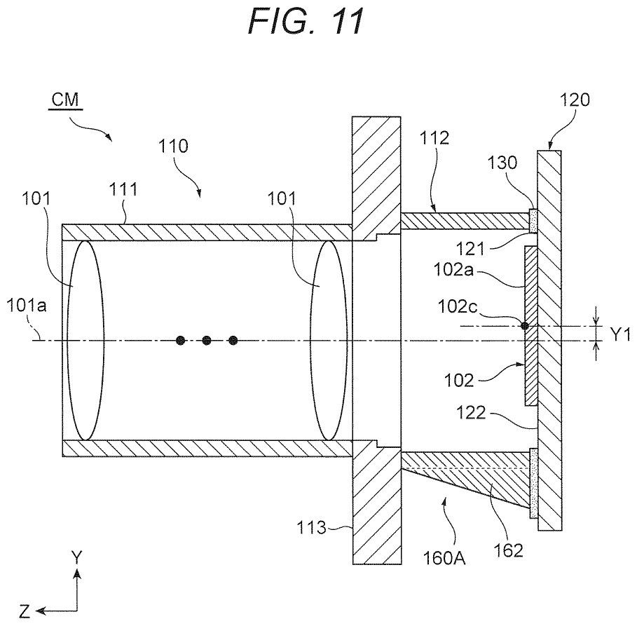

Hereinafter, an imaging device according to a second embodiment of the present disclosure will be described with reference to FIG. 11. FIG. 11 is a cross-sectional view illustrating the imaging device according to the second embodiment of the present disclosure, corresponding to FIG. 4B. The configuration of the displacement adjustment part 160A of the imaging device 100A according to the present embodiment is different: from the configuration of the displacement adjustment part 160 of the imaging device 100 according to the first embodiment described above. The other configurations of the imaging device 100A according to the present embodiment are similar to those of the imaging device 100 according to the first embodiment described above, and thus, the same reference numerals will be given to similar portions, and the description thereof will be omitted.

In the imaging device 100A according to the present embodiment, the displacement adjustment part 160A includes a rib 162 protruding from an outer peripheral surface of a portion adjacent to the wide portion 122 of the holder base part 112. With such a configuration, the rigidity of the portion adjacent to the wide portion 122 of the holder base part 112 is higher than the rigidity of the portion adjacent to the narrow portion 121 of the holder base part 112.

As a result, relative displacement between a partial portion adjacent to the narrow portion 121 of the holder base part 112 and the substrate 120 can be easier than relative displacement between a portion adjacent to the wide portion 122 and having the rib 162 of the holder base part 112 and the substrate 120. Therefore, according to the present embodiment, it is also possible to provide an imaging device 100A capable of achieving the same effects as that of the first embodiment described above, and reducing the optical axis deviation of the optical lens 101 with respect to the imaging element 102 caused by thermal deformation of the components.

In addition, the thickness of the portion adjacent to the narrow portion 121 and the thickness of the portion adjacent to the wide portion 122 of the holder base part 112 can be the same, making it possible to facilitate dimensional management in manufacturing the imaging device 100A, thereby improving dimensional accuracy and improving reliability in the optical axis deviation reducing effect. In the present embodiment, the rib 162 has a triangular shape, but the shape of the rib 162 and the number of ribs 162 are not particularly limited. In addition, the rib 162 may be provided not only on the bottom wall portion of the rectangular holder base part 112 adjacent to the wide portion 122 but also on the side wall portion of the rectangular holder base part 112 adjacent to the wide portion 122. The displacement adjustment part 160A may include a thin portion 161, similarly to the displacement adjustment part 160 according to the first embodiment described above.

### Third Embodiment

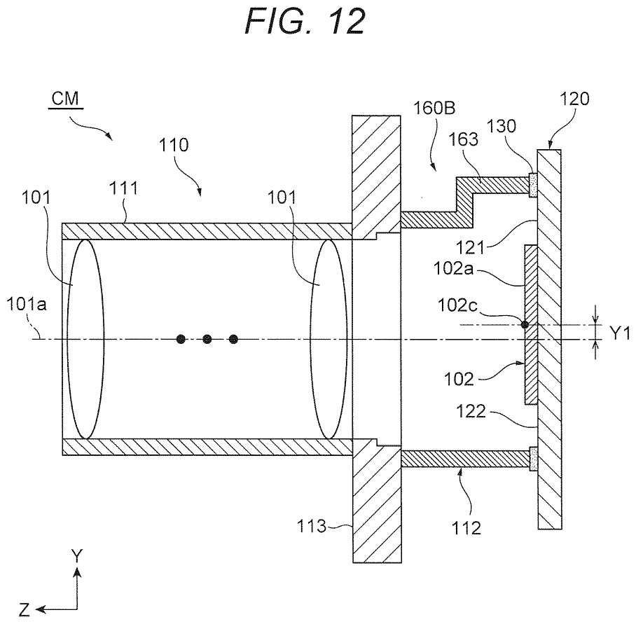

Hereinafter, an imaging device according to a third embodiment of the present disclosure will be described with reference to FIG. 12. FIG. 12 is a cross-sectional view illustrating the imaging device according to the third embodiment of the present disclosure, corresponding to FIG. 4B. The configuration of the displacement adjustment part 160B of the imaging device 100B according to the present embodiment is different from the configuration of the displacement adjustment part 160 of the imaging device 100 according to the first embodiment described above. The other configurations of the imaging device 100B according to the present embodiment are similar to those of the imaging device 100 according to the first embodiment described above, and thus, the same reference numerals will be given to similar portions, and the description thereof will be omitted.

In the imaging device 100B according to the present embodiment, the displacement adjustment part 160B includes a bent portion 163 provided in a portion adjacent to the narrow portion 121 of the holder base part 112. With such a configuration, the rigidity of the portion adjacent to the narrow portion 121 of the holder base part 112 is lower than the rigidity of the portion adjacent to the wide portion 122 of the holder base part 112.

As a result, relative displacement between the portion adjacent to the narrow portion 121 and having the bent portion 163 of the holder base part 112 and the substrate 120 can be easier than relative displacement between the partial portion adjacent to the wide portion 122 of the holder base part 112 and the substrate 120. Therefore, according to the present embodiment, it is also possible to provide an imaging device 100B capable of achieving the same effects as that of the first embodiment described above, and reducing the optical axis deviation of the optical lens 101 with respect to the imaging element 102 caused by thermal deformation of the components.

In addition, the thickness of the portion adjacent to the narrow portion 121 and the thickness of the portion adjacent to the wide portion 122 of the holder base part 112 can be the same, making it possible to facilitate dimensional management in manufacturing the imaging device 100B, thereby improving dimensional accuracy and improving reliability in the optical axis deviation reducing effect. Further, by forming the bent portion 163 as the thin portion 161, it is possible to facilitate relative displacement between the portion adjacent to the narrow portion 121 and having the bent portion 163 of the holder base part 112 and the substrate 120, thereby expanding the range in which the optical axis deviation can be reduced. Further, the bent portion 163 may be provided not only on the upper wall portion of the rectangular holder base part 112 adjacent to the narrow portion 121 but also on the side wall portion of the rectangular holder base part 112 adjacent to the narrow portion 121.

### Fourth Embodiment

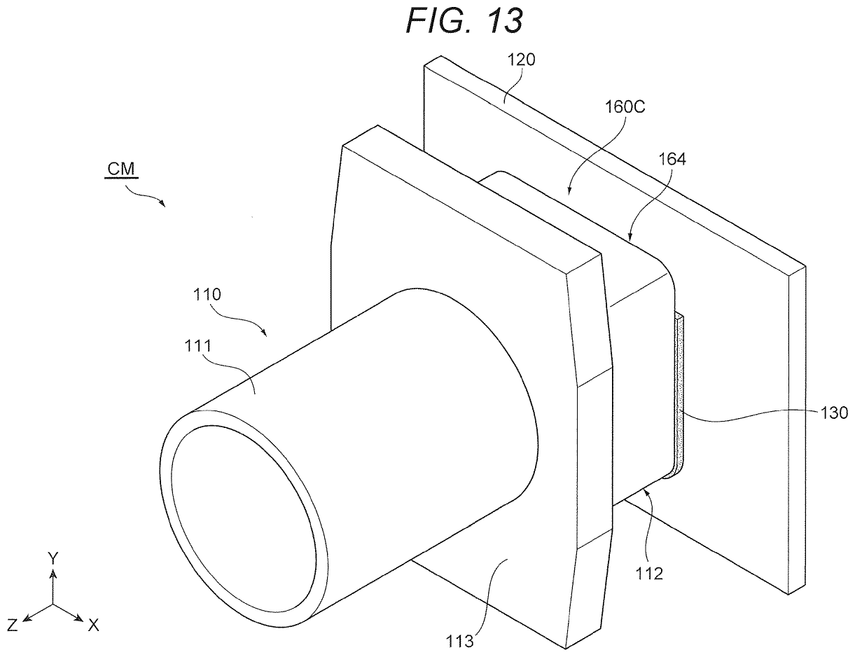

Hereinafter, an imaging device according to a fourth embodiment of the present disclosure will be described with reference to FIG. 13. FIG. 13 is a perspective view illustrating the imaging device according to the fourth embodiment of the present disclosure, corresponding to FIG. 3. The configuration of the displacement adjustment part 160° C. of the imaging device 100C according to the present embodiment is different from the configuration of the displacement adjustment part 160 of the imaging device 100 according to the first embodiment described above. The other configurations of the imaging device 100C according to the present embodiment are similar to those of the imaging device 100 according to the first embodiment described above, and thus, the same reference numerals will be given to similar portions, and the description thereof will be omitted.

In the imaging device 100C according to the present embodiment, the displacement adjustment part 160C includes a displacement allowing portion 164 by which the joining part 130 has a smaller joining strength in a portion adjacent to the narrow portion 121 than in the other portion. The displacement allowing portion 164 is, for example, a portion where the joining part 130 is not provided between the holder base part 112 and the substrate 120, and is provided between a partial portion of the holder base part 112 adjacent to the narrow portion 121 and the substrate 120. The displacement allowing portion 164 is, for example, a minute gap between the holder base part 112 and the substrate 120, or a surface on which the holder base part 112 and the substrate 120 are in contact with each other.

With such a configuration, relative displacement between a partial portion of the holder base part 112 adjacent to the narrow portion 121 and the substrate 120 can be easier than relative displacement between the other portion of the holder base part 112 adjacent to the wide portion 122 and the substrate 120 Therefore, according to the present embodiment, it is also possible to provide an imaging device 100C capable of achieving the same effects as that of the first embodiment described above, and reducing the optical axis deviation of the optical lens 101 with respect to the imaging element 102 caused by thermal deformation of the components.

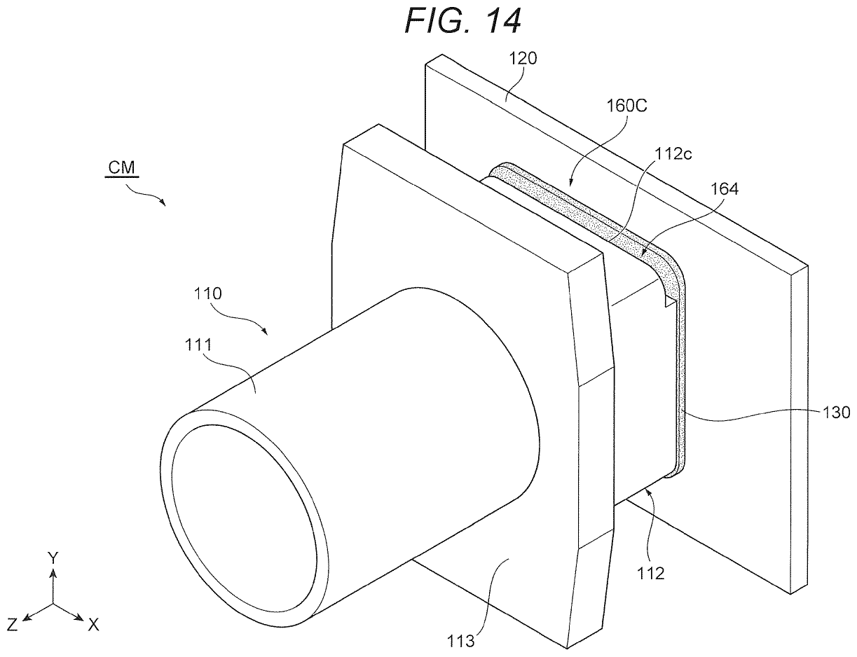

Note that the displacement allowing portion 164 can also be formed using an adhesive having lower rigidity than the adhesive constituting the joining part 130. This makes it possible to ensure dust-proofness between the holder base part 112 and the substrate 120. Furthermore, the imaging device 100C according to the present embodiment is not limited to the above-described configuration. First to third modifications of the imaging device 100C according to the present embodiment will be described below with reference to FIGS. 14 to 16.

FIG. 14 is a perspective view illustrating a first modification of the imaging device 100C according to the fourth embodiment, corresponding to FIG. 3 In the present modification, the joining part 130 is formed over the entire periphery of the open end of the holder base part 112. In addition, the displacement allowing portion 164 is formed by a notch portion 112c formed in a portion adjacent to the narrow portion 121 of the holder base part 112. In the displacement allowing portion 164 provided in the portion adjacent to the narrow portion 121 of the holder base part 112, the holder base part 112 has a gap from the joining part 130 and is not joined to the substrate 120.

Due to the displacement allowing portion 164, the joining part 130 has a smaller joining strength in a portion adjacent to the narrow portion 121 than in the other portion. Therefore, in the present modification, it is also possible to provide an imaging device 100 capable of achieving the same effects as that of the first embodiment described above, and reducing the optical axis deviation of the optical lens 101 with respect to the imaging element 102 caused by thermal deformation of the components. Note that the notch portion 112c may be closed by being filled with an adhesive having lower rigidity than the adhesive constituting the joining part 130. This makes it possible to ensure dust-proofness between the holder base part 112 and the substrate 120. The notch portion 112c may be a slit.

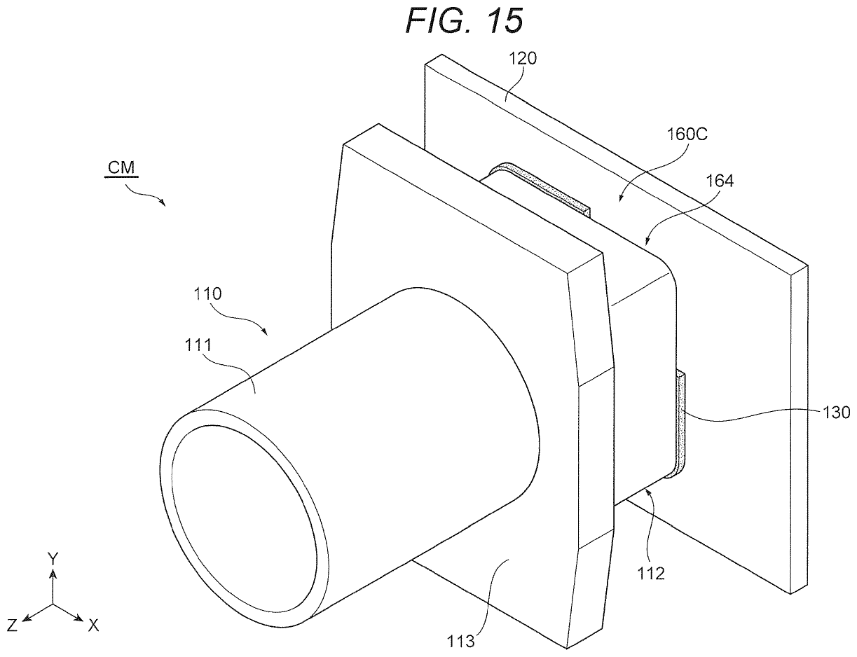

FIG. 15 is a perspective view illustrating a second modification of the imaging device 100C according to the fourth embodiment, corresponding to FIG. 3 In the present modification, the joining part 130 is not formed and the displacement allowing portion 164 is formed in partial portions of wall portions constituting two sides of the rectangular holder base part 112 facing two sides of the rectangular substrate 120 adjacent to the narrow portion 121. The lengths of the displacement allowing portion 164 in the width direction and the vertical direction of the vehicle can be adjusted according to the offset amounts X1 and Y1. Therefore, in the present modification, it is also possible to provide an imaging device 100 capable of achieving the same effects as that of the first embodiment described above, and reducing the optical axis deviation of the optical lens 101 with respect to the imaging element 102 caused by thermal deformation of the components.

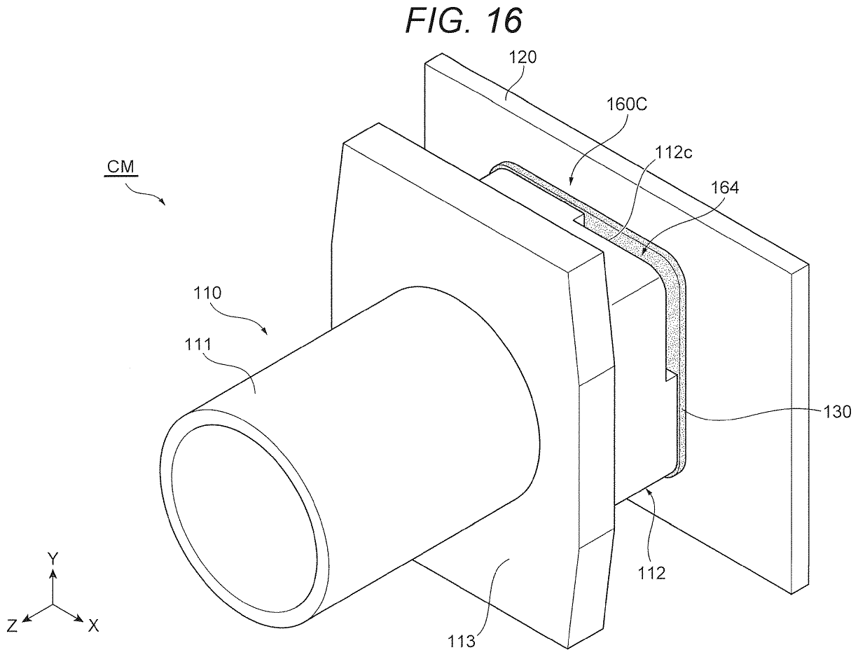

FIG. 16 is a perspective view illustrating a third modification of the imaging device 100C according to the fourth embodiment, corresponding to FIG. 3 In the present modification, a notch portion 112c is provided in partial portions of wall portions constituting two sides of the rectangular holder base part 112 facing two sides of the rectangular substrate 120 adjacent to the narrow portion 121 to form a displacement allowing portion 164. The lengths of the displacement allowing portion 164 in the width direction and the vertical direction of the vehicle can be adjusted according to the offset amounts X1 and Y1. Therefore, in the present modification, it is also possible to provide an imaging device 100 capable of achieving the same effects as that of the first embodiment described above, and reducing the optical axis deviation of the optical lens 101 with respect to the imaging element 102 caused by thermal deformation of the components.

Although the imaging devices according to the embodiments of the present disclosure have been described in detail with reference to the drawings, the specific configurations are not limited to the embodiments, and design changes and the like made without departing from the gist of the present disclosure also fall within the present disclosure.

Reference Signs List

| | |
|---|---|
| 100 | imaging device |
| 100A | imaging device |
| 100B | imaging device |
| 100C | imaging device |
| 101 | optical lens |
| 101a | optical axis |
| 102 | imaging element |
| 102a | Imaging surface |
| 102c | center |
| 110 | lens holder |
| 111 | lens barrel |
| 112 | holder base part |
| 120 | substrate |
| 121 | narrow portion |
| 122 | wide portion |
| 130 | joining part |
| 160 | displacement adjustment part |
| 160A | displacement adjustment part |
| 160B | displacement adjustment part |
| 160C | displacement adjustment part |
| 161 | thin portion |
| 162 | rib |
| 163 | bent portion |
| 164 | displacement allowing portion |

1. An imaging device comprising: a lens holder that holds an optical lens; a substrate on which an imaging element having an imaging surface intersecting with an optical axis of the optical lens is mounted; and a joining part that joins the lens holder to the substrate,
wherein the lens holder includes a lens barrel that holds the optical lens, and a holder base part that supports the lens barrel and is joined to the substrate via the joining part to surround the imaging element,
the substrate includes a narrow portion that surrounds a partial portion of an outer periphery of the imaging element inside the holder base part, and a wide portion that surrounds the remaining portion of the outer periphery of the imaging element inside the holder base part, the wide portion being wider than the narrow portion, and
the imaging device further comprises a displacement adjustment part that makes relative displacement between the lens barrel and the substrate in a direction in which the imaging element moves from the narrow portion toward the wide portion easier than relative displacement between the lens barrel and the substrate in a direction in which the imaging element moves from the wide portion toward the narrow portion.

2. The imaging device according to claim 1, wherein the displacement adjustment part includes a thin portion by which the holder base part is thinner in a portion adjacent to the narrow portion than in the other portion.

3. The imaging device according to claim 1, wherein the displacement adjustment part includes a rib protruding from an outer peripheral surface of a portion adjacent to the wide portion of the holder base part.

4. The imaging device according to claim 1, wherein the displacement adjustment part includes a bent portion provided in a portion adjacent to the narrow portion of the holder base part.

5. The imaging device according to claim 1, wherein the displacement adjustment part includes a displacement allowing portion by which the joining part has a smaller joining strength in a portion adjacent to the narrow portion than in the other portion.

6. The imaging device according to claim 1, wherein
the lens barrel holds the optical lens in a state where the optical axis is offset from the center of the imaging surface,
the holder base part is provided in a tubular shape coaxially with the lens barrel,
the narrow portion surrounds the partial portion of the outer periphery of the imaging element on a side opposite to an offset side of the optical axis with respect to the center of the imaging surface, and
the wide portion surrounds the remaining portion of the outer periphery of the imaging element on the offset side.

7. The imaging device according to claim 6, wherein
the displacement adjustment part includes a thin portion by which the holder base part is thinner in a portion adjacent to the narrow portion than in the other portion, and
a difference in thickness between the thin portion and the other portion is proportional to an offset amount of the optical axis with respect to the center of the imaging surface.
